(19) United States
(12) Patent Application Publication
(10) Pub. No.: US 2023/0183612 A1
(43) Pub. Date: Jun. 15, 2023

(54) Soil Release Polyesters For Use In Detergent Compositions

(71) Applicant: Clariant International Ltd., Muttenz (CH)

(72) Inventors: Martijn GILLISSEN, Bocholtz (NL); Hiroe YAMADA, Frankfurt am Main (DE); Kevin James MUTCH, Frankfurt am Main (DE)

(73) Assignee: Clariant International Ltd., Muttenz (CH)

(21) Appl. No.: 17/926,058

(22) PCT Filed: May 19, 2021
(86) PCT No.: PCT/EP2021/063267

§ 371 Date: Nov. 17, 2022

(30) Foreign Application Priority Data
May 20, 2020 (EP) 20175707.7

(51) Int. Cl. C11D 3/37; C08G 63/672; C11D 11/00; C11D 1/83; C11D 3/00

(52) U.S. Cl. CPC C11D 3/3715; C08G 63/672; C11D 1/83; C11D 3/0036; C11D 11/0017; C11D 1/22

(57) ABSTRACT

Soil release polyesters for use in detergent compositions Polyesters are described comprising one or more structural units of the formula (I)

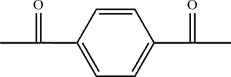

and one or more structural units of the formula (II)

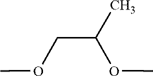

and one or more terminal groups of the formula (III-a) or mixtures thereof

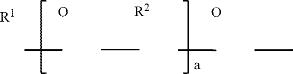

wherein
R¹ is a linear or branched alkyl group comprising from 7 to 30 carbon atoms or a linear or branched alkenyl group comprising one or more double bonds and from 7 to 30 carbon atoms or mixtures thereof,
a is, based on a molar average, a number from 1 to 200, and
R² is a linear or branched alkylene group (CₘH₂ₘ) with m being a number from 2 to 10 or mixtures thereof.

The polyesters are particularly suited to be used as soil release agents.

The invention relates to specific polyesters, a process for their preparation, their use as soil release agents, their use in detergent compositions, detergent compositions comprising the polyesters and surfactants and solutions or dispersions comprising the polyesters.

Polyester containing fabrics can be surface modified to increase the hydrophilicity of the fabric, which can improve soil removal. Such surface modification can be achieved through direct treatment of the fabric, as outlined for example in GB 1,088,984, or more preferably through deposition of a surface modifying polymer in a washing process, as disclosed for example in US 3,962,152. The renewable soil release finish imparted through washing ensures the continuous protection of the fiber from oily stains.

The polymers used in these processes typically consist of a polyester midblock with either one or two endblocks of polyethylene glycol, as further outlined in US 3,959,230 and US 3,893,929.

The inclusion of anionic moieties in the polymer structure is known to improve the efficacy of these soil release polymers and in particular, improve their anti-redeposition properties. For example, DE 10 2007 013 217 and EP 1 966 273 disclose anionic polyesters that may be used as soil release agents in laundry detergents. Such anionic soil release polymers are particularly well suited for use in powder detergents due to their handling properties and compatibility with the detergent composition.

The use of nonionic soil release agents in liquid laundry detergents is well known in the art. GB 1,466,639, US 4,132,680, US 4,702,857, EP 0 199 403, US 4,711,730, US 4,713,194 and US 4,759,876 disclose aqueous detergent compositions containing soil release polymers.

A typical property of existing soil release polymers described in the prior art is their tendency to significantly reduce the viscosity of detergent compositions. While comparatively low viscosities of concentrates to be used for the preparation of detergent compositions are advantageous for their handling, e.g. with regard to pumpability or dosage consistency, end-consumers tend to correlate higher viscosities of detergent compositions with better performance. To compensate for the reduction in viscosity by the addition of such soil release polymers, the formulator must add additional components to the detergent composition to regain this viscosity. The latter is non-ideal as this can bring additional costs and effort. Moreover, the use of additional materials is not preferred from an environmental aspect.

Therefore, it was an object of the present invention to provide new polyesters which possess or lead to advantageous soil release and viscosity properties and preferably do not reduce or even increase the viscosity of detergent compositions.

Surprisingly, it has been found that this problem is solved by polyesters comprising one or more structural units of the formula (I)

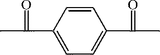

and one or more structural units of the formula (II)

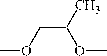

and one or more terminal groups of the formula (III-a) or mixtures thereof

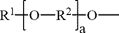

wherein
R¹ is a linear or branched, preferably a linear, alkyl group comprising from 7 to 30 carbon atoms or a linear or branched, preferably a linear, alkenyl group comprising one or more double bonds and from 7 to 30 carbon atoms or mixtures thereof,
preferably a linear or branched, preferably a linear, alkyl group comprising from 10 to 18 carbon atoms or a linear or branched, preferably a linear, alkenyl group comprising one or more double bonds and from 10 to 18 carbon atoms or mixtures thereof,
and more preferably a linear or branched, preferably a linear, alkyl group comprising from 10 to 15 carbon atoms or a linear or branched, preferably a linear, alkenyl group comprising one or more double bonds and from 10 to 15 carbon atoms or mixtures thereof,
a is, based on a molar average, a number from 1 to 200, preferably from 10 to 200, more preferably from 20 to 150 and even more preferably from 60 to 150, and
R² is a linear or branched alkylene group (CₘH₂ₘ) with m being a number from 2 to 10 or mixtures thereof, preferably with m being a number from 2 to 6 or mixtures thereof, more preferably is selected from the group consisting of (C₂H₄), (C₃H₆), (C₄H₈) and mixtures thereof, even more preferably is selected from the group consisting of (C₂H₄), (C₃H₆) and mixtures thereof, and particularly preferably is (C₂H₄).

Therefore, a subject matter of the present invention is polyesters comprising one or more structural units of the formula (I)

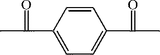

and one or more structural units of the formula (II)

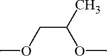

and one or more terminal groups of the formula (III-a) or mixtures thereof

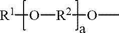

wherein
R¹ is a linear or branched, preferably a linear, alkyl group comprising from 7 to 30 carbon atoms or a linear or branched, preferably a linear, alkenyl group
comprising one or more double bonds and from 7 to 30 carbon atoms or mixtures thereof,
preferably a linear or branched, preferably a linear, alkyl group comprising from 10 to 18 carbon atoms or a linear or branched, preferably a linear, alkenyl group comprising one or more double bonds and from 10 to 18 carbon atoms or mixtures thereof,
and more preferably a linear or branched, preferably a linear, alkyl group comprising from 10 to 15 carbon atoms or a linear or branched, preferably a linear, alkenyl group comprising one or more double bonds and from 10 to 15 carbon atoms or mixtures thereof,
a is, based on a molar average, a number from 1 to 200, preferably from 10 to 200, more preferably from 20 to 150 and even more preferably from 60 to 150, and
R² is a linear or branched alkylene group (CₘH₂ₘ) with m being a number from 2 to 10 or mixtures thereof, preferably with m being a number from 2 to 6 or mixtures thereof, more preferably is selected from the group consisting of (C₂H₄), (C₃H₆), (C₄H₈) and mixtures thereof, even more preferably is selected from the group consisting of (C₂H₄), (C₃H₆) and mixtures thereof, and particularly preferably is (C₂H₄).

The polyesters of the invention possess or lead to advantageous soil release and viscosity properties and preferably do not reduce or even increase the viscosity of detergent compositions. The inventive polyesters additionally e.g. show beneficial compatibility with liquid detergent compositions, detergency enhancement, advantageous hydrolysis stability, and beneficial anti-greying effects.

EP 0 442 101 discloses polyesters containing nonionic surfactants in a condensed form, their preparation and their use in detergents.

WO 97/30141 discloses polyetherestercarbonate as dirt dissolving polymers in washing and textile adjuvants.

WO 95/32232 discloses soil release polymers that effectively remove greasy soils.

The one or more structural units of the formula (I) of the polyesters of the invention are derived from terephthalic acid or its salts or its dialkyl esters, preferably its (C₁-C₄)-dialkyl esters and more preferably its dimethyl ester, or mixtures thereof.

In addition to the one or more structural units of the formula (I) further structural units derived from other di- or polycarboxylic acids or their salts or their (di)alkylesters can be used in the polyesters of the invention, such as, phthalic acid, isophthalic acid, 5-sulfoisophthalic acid, 3-sulfophthalic acid, 4-sulfophthalic acid, naphthalene-1 ,4-dicarboxylic acid, naphthalene-2,6,-dicarboxylic acid, tetrahydrophthalic acid, trimellitic acid, diphenoxyethane-4,4′-dicarboxylic acid, diphenyl-4,4′-dicarboxylic acid, 2,5-furandicarboxylic acid, adipic acid, sebacic acid, decan-1,10-dicarboxylic acid, fumaric acid, succinic acid, 1 ,4-cyclohexanedicarboxylic acid, cyclohexanediacetic acid, glutaric acid, azelaic acid, or their salts or their (di)alkyl esters, preferably their (C₁-C₄)-(di)alkyl esters and more preferably their (di)methyl esters, or mixtures thereof. Typically, such further structural units derived from other di- or polycarboxylic acids or their salts or their (di)alkylesters would be present to a minor extent, for example in an amount smaller than 5 wt.-%, based on the total weight of the polyester of the invention.

The one or more structural units of the formula (II) of the polyesters of the invention are derived from 1,2-propyleneglycol.

In addition to the one or more structural units of the formula (II), further structural units derived from other glycols can be used in the polyesters of the invention, such as, ethyleneglycol, 1 ,3-propyleneglycol, 2-methyl-1,3-propanediol, 1,4-butanediol, 1,3-butanediol, 2,3-butanediol, 1,2-butanediol, 2,2-dimethyl-1,3-propanediol, 1,2-pentanediol, 1,5-pentanediol, 1,2-hexanediol, 1,6-hexanediol or mixtures thereof. Typically, such further structural units would be present to a minor extent, for example in an amount smaller than 5 wt.-% based on the total weight of the polyester of the invention.

In addition, further structural units derived from triols or tetraols can be used in the polyesters of the invention, such as, glycerol, pentaerythritol or mixtures thereof. Typically, such further structural units would be present to a minor extent, for example in an amount smaller than 5 wt.-% based on the total weight of the polyester of the invention.

Examples of the alkyl and alkenyl groups R¹ in the one or more terminal groups of the formula (III-a) are, for example, linear or branched heptyl, octyl (e.g. capryl), nonyl, decyl, undecyl, dodecyl, tridecyl (e.g. isotridecyl), tetradecyl, pentadecyl, hexadecyl, heptadecyl, octadecyl, nonadecyl, icosyl, henicosyl, docosyl, tricosyl, tetraicosyl, heptenyl, octenyl, nonenyl, decenyl, dodecenyl, tetradecenyl, hexadecenyl, octadecenyl, octadecadienyl, octadecatrienyl, eicosenyl, eicosadienyl, eicosatetraenyl, docosenyl, docosahexaenyl, tetracosenyl, or mixtures thereof.

The groups R¹ in the one or more terminal groups of the formula (III-a) may also be mixtures which have been derived or obtained from natural sources and comprise one or more alkyl and/or one or more alkenyl groups and in case these mixtures comprise one or more alkenyl groups, they may also be partially or totally hydrogenated. Examples of such mixtures are cocoyl, partially or totally hydrogenated variants of cocoyl, talloyl or partially or totally hydrogenated variants of talloyl.

Among the linear alkyl groups comprising from 10 to 15 carbon atoms or mixtures thereof in the definition of R¹, which also can be described as linear C₁₀-C₁₅ alkyl or mixtures thereof, R¹ preferably is selected from the group consisting of lauryl, myristyl and mixtures thereof.

In a preferred embodiment of the invention, R¹ in the one or more terminal groups of the formula (III-a) is selected from the group consisting of linear or branched C₁₀-C₁₅ alkyl (such as lauryl, myristyl or isotridecyl), cocoyl, partially or totally hydrogenated variants of cocoyl, talloyl, partially or totally hydrogenated variants of talloyl and mixtures thereof, more preferably is selected from the group consisting of linear or branched, preferably linear, C₁₀-C₁₅ alkyl, talloyl, partially or totally hydrogenated variants of talloyl and mixtures thereof, even more preferably is selected from the group consisting of linear or branched, preferably linear, C₁₀-C₁₅ alkyl, partially or totally hydrogenated variants of talloyl and mixtures thereof and particularly preferably is selected from the group consisting of lauryl, myristyl, partially or totally hydrogenated variants of talloyl and mixtures thereof.

In a further preferred embodiment of the invention, R¹ is a linear or branched, preferably a linear, alkyl group comprising from 7 to 30 carbon atoms or mixtures thereof, more preferably a linear or branched, preferably a linear, alkyl group comprising from 10 to 18 carbon atoms or mixtures thereof, even more preferably a linear or branched, preferably a linear, alkyl group comprising from 10 to 15 carbon atoms or mixtures thereof, and particularly preferably is selected from the group consisting of lauryl, myristyl and mixtures thereof.

In the case that at least two different types of [O(CₘH₂ₘ)] groups, for example [O(C₂H₄)], [O(C₃H₆)] and [O(C₄H₈)] groups, exist in a terminal group of the formula (III-a), they may be arranged blockwise, alternating, periodically and/or statistically, preferably blockwise and/or statistically. This means that in a terminal group of the formula (III-a), the [O(CₘH₂ₘ)] groups, and e.g. the groups [O(C₂H₄)], [O(C₃H₆)] and [O(C₄H₈)], may be arranged, for example, in a purely statistically or blockwise form but may also be arranged in a form which could be considered as both statistical and blockwise, e.g. small blocks of [(OC₂H₄)] and [O(CsHs)] arranged in a statistical manner, or in a form wherein adjacent instances of statistical and blockwise arrangements of the groups [O(C₂H₄)], [O(C₃H₆)] and [O(C₄H₈)] exist.

Any of the groups [O(CₘH₂ₘ)], e.g. any of the groups [O(C₂H₄)], [O(C₃H₆)] and [O(C₄H₈)], can be linked to R¹— and —O in a terminal group of the formula (III-a). This means, for example, that both, R¹— and —O in a terminal group of the formula (III-a), may be connected to a [O(C₂H₄)] group, they may both be connected to a [O(CsHs)] group, they may both be connected to a [O(C₄H₈)] group or they may be connected to different groups selected from [O(C₂H₄)], [O(C₃H₆)] and [O(C₄H₈)].

In the case that one molecule of the polyesters of the invention comprises two or more terminal groups of the formula (III-a) the definition of R¹, R² and “a” may vary between those terminal groups.

In a preferred embodiment of the invention R¹ is a linear or branched, preferably a linear, alkyl group comprising from 7 to 30 carbon atoms or a linear or branched, preferably a linear, alkenyl group comprising one or more double bonds and from 7 to 30 carbon atoms or mixtures thereof, and preferably a linear or branched, preferably a linear, alkyl group comprising from 10 to 18 carbon atoms or a linear or branched, preferably a linear, alkenyl group comprising one or more double bonds and from 10 to 18 carbon atoms or mixtures thereof, and “a” is, based on a molar average, a number from 60 to 150.

In a further preferred embodiment of the invention, R¹ is a linear or branched, preferably a linear, alkyl group comprising from 10 to 15 carbon atoms or a linear or branched, preferably a linear, alkenyl group comprising one or more double bonds and from 10 to 15 carbon atoms, or mixtures thereof, and “a” is, based on a molar average, a number from 1 to 200, preferably from 10 to 200, more preferably from 20 to 150 and even more preferably from 60 to 150. In this preferred embodiment of the invention, R¹ preferably is a linear or branched, preferably a linear, alkyl group comprising from 10 to 15 carbon atoms or mixtures thereof and “a” is, based on a molar average, a number from 1 to 200, preferably from 10 to 200, more preferably from 20 to 150 and even more preferably from 60 to 150, and more preferably, R¹ is selected from the group consisting of lauryl, myristyl and mixtures thereof and “a” is, based on a molar average, a number from 1 to 200, preferably from 10 to 200, more preferably from 20 to 150 and even more preferably from 60 to 150.

In a preferred embodiment of the invention the polyesters comprise one or more polyalkyleneglycol-derived structural units of the formula (IV-a)

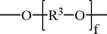

or mixtures thereof, wherein
f is, based on a molar average, a number from 2 to 200, preferably from 10 to 200, more preferably from 20 to 150 and even more preferably from 60 to 150, and
R³ is a linear or branched alkylene group (CₙH₂ₙ) with n being a number from 2 to 10 or mixtures thereof, preferably with n being a number from 2 to 6 or mixtures thereof, more preferably is selected from the group consisting of (C₂H₄), (C₃H₆), (C₄H₈) and mixtures thereof, even more preferably is selected from the group consisting of (C₂H₄), (C₃H₆) and mixtures thereof, and particularly preferably is (C₂H₄).

In the case that at least two different types of [(CₙH₂ₙ)O] groups, for example [(C₂H₄)O], [(C₃H₆)O] and [(C₄H₈)O] groups, exist in a structural unit of the formula (IV-a), they may be arranged blockwise, alternating, periodically and/or statistically, preferably blockwise and/or statistically. This means that in a structural unit of the formula (IV-a), the [(CₙH₂ₙ)O] groups, and e.g. the groups [(C₂H₄)O], [(C₃H₆)O] and [(C₄H₈)O], may be arranged, for example, in a purely statistically or blockwise form but may also be arranged in a form which could be considered as both statistical and blockwise, e.g. small blocks of [(C₂H₄)O] and [(C₃H₆)O] arranged in a statistical manner, or in a form wherein adjacent instances of statistical and blockwise arrangements of the groups [(C₂H₄)O], [(C₃H₆)O] and [(C₄H₈)O] exist.

Within the structure element —[R³—O]f— in a structural unit of the formula (IV-a) any of the groups [(CₙH₂ₙ)O], e.g. any of the groups [(C₂H₄)O], [(C₃H₆)O] and [(C₄H₈)O], can form an end group of the structure element —[R³—O]f—. This means, for example, that the two end groups of the structure element —[R³—O]f— in a structural unit of the formula (IV-a) may be formed by [(C₂H₄)O] groups, may be formed by [(C₃H₆)O] groups, may be formed by [(C₄H₈)O] groups or may be formed by different groups selected from [(C₂H₄)O], [(C₃H₆)O] and [(C₄H₈)O].

In the case that one molecule of the polyesters of the invention comprises two or more structural units of the formula (IV-a) the definition of R³ and “f” may vary between those structural units.

In the polyesters of the invention, the amount of the one or more terminal groups of the formula (III-a) or mixtures thereof preferably is at least 40 wt.-%, more preferably is from 40 to 90 wt.-% and even more preferably is from 50 to 90 wt.-%, in each case based on the total weight of the polyester.

In the polyesters of the invention, the combined amount of the one or more structural units of the formula (I), and the one or more structural units of the formula (II), and the one or more terminal groups of the formula (III-a) or mixtures thereof, and, if present, the one or more polyalkyleneglycol-derived structural units of the formula (IV-a) or mixtures thereof, preferably is at least 50 wt.-%, more preferably is at least 60 wt.-% and even more preferably is at least 70 wt.-%, in each case based on the total weight of the polyester.

Preferably, the weight average molecular weight (Mw) of the inventive polyesters is from 5000 to 20000 g/mol.

The weight average molecular weight (Mw) of the inventive polyesters may be determined by GPC analysis, preferably as detailed in the following: 10 µl of sample is injected onto a PSS Suprema column of dimensions 300 x 8 mm with porosity 30 Å and particle size 10 µm. The detection is monitored at 235 nm on a multiple wavelength detector. The employed eluent is 1.25 g/l of disodium hydrogen phosphate in a 45 / 55 % (v/v) water / acetonitrile mixture. Separations are conducted at a flow rate of 0.8 ml/minute. Quantification is performed by externally calibrating standard samples of different molecular weight polyethylene glycols.

Preferably, the number of structural units of the formula (I) in the polyesters of the invention is, based on a molar average, from 2 to 60, more preferably from 2 to 40, even more preferably from 2 to 30, particularly preferably from 2 to 20 and especially preferably from 5 to 20.

The polyesters of the invention comprise one or more terminal groups of the formula (III-a) or mixtures thereof. In addition to these one or more terminal groups or mixtures thereof, the inventive polyesters may comprise further terminal groups, preferably selected from the group consisting of —OH, —OCH₂CH(CH₃)OH, —OCH(CH₃)CH₂OH and mixtures thereof. In case the polyesters of the invention comprise one or more polyalkyleneglycol-derived structural units of the formula (IV-a) or mixtures thereof, the polyesters may also comprise terminal groups of the formula —O—[R³—O]f—H wherein R³ and “f” have the meaning given above.

Preferably, the polyester molecules of the invention comprise two or more terminal groups of the formula (III-a) or mixtures thereof. Even more preferably, all terminal groups of the polyester molecules of the invention are terminal groups of the formula (III-a) or mixtures thereof.

In a preferred embodiment of the invention, the inventive polyesters consist of
a1) one or more structural units of the formula (I) and
a2) one or more structural units of the formula (II) and
a3) one or more terminal groups of the formula (III-a) or mixtures thereof.

In a further preferred embodiment of the invention, the inventive polyesters consist of
b1) one or more structural units of the formula (I) and
b2) one or more structural units of the formula (II) and
b3) one or more terminal groups of the formula (III-a) or mixtures thereof, and
b4) one or more polyalkyleneglycol-derived structural units of the formula (IV-a) or mixtures thereof.

For the preparation of the polyesters of the invention, typically a two-stage process is used of either direct esterification of diacids and diols or transesterification of diesters and diols, followed by a polycondensation reaction under reduced pressure.

A further subject matter of the invention is a process for the preparation of the inventive polyesters, comprising the steps of: heating one or more substances of the formula Q1—OOC—C₆H₄—COO—Q2, wherein Q1 and Q2, independently of one another, are selected from the group consisting of H and (C₁-C₄)-alkyl and preferably are CH₃, and 1,2-propyleneglycol, and one or more substances of the formula R¹—[O—R²]ₐ—OH or mixtures thereof, wherein R¹, R² and “a” have the meaning given above, with the addition of a catalyst, to temperatures of from 160 to 220° C., preferably beginning at atmospheric pressure, and then continuing the reaction under reduced pressure at temperatures of from 160 to 240° C.

Reduced pressure preferably means a pressure of from 0.1 to 900 mbar and more preferably a pressure of from 0.5 to 500 mbar.

Typical transesterification and condensation catalysts known in the art can be used for the inventive process for the preparation of the inventive polyesters, such as antimony, germanium and titanium-based catalysts. Preferably, tetraisopropyl orthotitanate (IPT) and sodium acetate (NaOAc) are used as the catalyst system in the inventive process for the preparation of the polyesters of the invention.

In order to obtain polyesters of the invention comprising one or more polyalkyleneglycol-derived structural units of the formula —O—[R³—O]f— (IV—a) or mixtures thereof, the respective one or more polyalkyleneglycols of the formula HO—[ R³—O]f—H or mixtures thereof, may be employed in the inventive process for the preparation of the polyesters of the invention.

The inventive polyesters may advantageously be used as soil release agents.

A further subject matter of the invention therefore is the use of one or more polyesters of the invention as soil release agents. “Soil release agent” as used herein means an agent that enhances soil removal during laundering by modifying the surface of the fabric that is laundered, preferably by increasing surface polarity.

The inventive polyesters may advantageously be used in detergent compositions.

A further subject matter of the invention therefore is the use of one or more polyesters of the invention in detergent compositions.

A further subject matter of the invention is detergent compositions comprising
Z1) one or more polyesters of the invention and
Z2) one or more surfactants.

The inventive detergent compositions are preferably laundry detergent com positions.

The detergent compositions of the invention comprise the one or more polyesters of component Z1) preferably in an amount of at least 0.1 wt.-%, more preferably in an amount from 0.1 to 10 wt.-%, even more preferably in amount from 0.2 to 5 wt.-% and particularly preferably in an amount from 0.2 to 3 wt.-%, in each case based on the total weight of the detergent composition.

The detergent compositions of the invention comprise one or more surfactants as component Z2).

Surfactants assist in removing soil from textile materials and also assist in maintaining removed soil in solution or suspension in the wash liquor.

Preferably, the one or more surfactants of component Z2) of the detergent compositions of the invention are selected from the group consisting of anionic, nonionic, cationic and zwitterionic surfactants, and more preferably from the group consisting of anionic, nonionic and zwitterionic surfactants.

### Anionic Surfactants

Suitable anionic surfactants that may be used are any of the conventional anionic surfactant types typically used in detergent products. These include alkyl sulfonates, alkyl ether sulfates, alkyl sulfates, alkyl ester sulfonates and soaps. Preferred anionic surfactants are alkylbenzene sulfonates, alkyl ether sulfates, alkyl sulfates and soaps.

Preferred alkyl sulfonates are alkylbenzene sulfonates, particularly linear alkylbenzene sulfonates (LAS) having an alkyl chain length of C₈-C₁₅. Possible counter ions for concentrated alkaline liquids are ammonium ions, e.g. those generated by the neutralization of alkylbenzene sulfonic acid with one or more ethanolamines, for example monoethanolamine (MEA) and triethanolamine (TEA), or alternatively, alkali metals, e.g. those arising from the neutralization of alkylbenzene sulfonic acid with alkali hydroxides. The linear alkyl benzene sulfonate surfactants may be LAS with an alkyl chain length of preferably from 8 to 15 and more preferably from 12 to 14. The neutralization of the acid may be performed before addition to the detergent compositions of the invention or during the process of formulating the detergent compositions of the invention through excess addition of neutralizing agent.

Preferred alkyl ether sulfates (AES) are alkyl polyethoxylate sulfate anionic surfactants of the formula

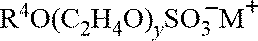

wherein
R⁴ is a saturated or unsaturated alkyl chain having preferably from 10 to 22 carbon atoms, and more preferably from 12 to 16 carbon atoms,
M⁺ is a cation which makes the compound water-soluble, preferably an ammonium cation, a substituted ammonium cation, an alkali metal cation, or other material chosen from the list of buffers, and
y averages preferably from 1 to 15, more preferably from 1 to 3 and even more preferably is 3.

Preferred alkyl sulfates (AS) are surfactants of the formula

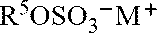

wherein
R⁵ is a linear or branched alkyl chain having preferably from 8 to 24 carbon atoms, and more preferably from 12 to 18 carbon atoms, and
M⁺ is a cation which makes the compound water-soluble, preferably an ammonium cation, a substituted ammonium cation, an alkali metal cation, or other material chosen from the list of buffers.

Soaps are preferably fatty acids and more preferably linear saturated or unsatured fatty acids having from 10 to 18 carbon atoms.

### Nonionic Surfactants

Nonionic surfactants include primary and secondary alcohol ethoxylates, especially C₈-C₂₀ aliphatic alcohol ethoxylated with an average of from 1 to 35 moles of ethylene oxide per mole of alcohol, and more especially the C₁₀-C₁₅ primary and secondary aliphatic alcohols ethoxylated with an average of from 1 to 10 moles of ethylene oxide per mole of alcohol. Non-ethoxylated nonionic surfactants include alkyl polyglycosides, glycerol monoethers and polyhydroxy amides (glucamides) such as N-methyl glucamides. Mixtures of nonionic surfactant may be used.

If included therein, the detergent compositions of the invention contain preferably from 0.2 to 40 wt.-% and more preferably from 1 to 20 wt.-% of a nonionic surfactant, such as alcohol ethoxylate, nonylphenol ethoxylate, alkylpolyglycoside, alkyldimethylamineoxide, ethoxylated fatty acid monoethanolamide, fatty acid monoethanolamide, polyhydroxy alkyl fatty acid amide, or N-acyl N-alkyl derivatives of glucosamine (“glucamides”).

### Zwitterionic Surfactants

The detergent compositions of the invention may comprise up to 10 wt.-% of a zwitterionic surfactant, e.g. amine oxide or betaine.

Typical amine oxides used are of the formula

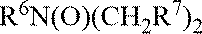

wherein
R⁶ is a long chain moiety and each CH₂R⁷ are short chain moieties, and
R⁷ is preferably selected from the group consisting of H, CH₃ and —CH₂OH.

In general, R⁶ is a primary or branched hydrocarbyl moiety with a chain length of from 8 to 18, which can be saturated or unsaturated. Preferably, R⁶ is a primary alkyl moiety with a chain length of 8 to 18 carbon atoms.

Preferred amine oxides have compositions wherein R⁶ is a C₈-C₁₈ alkyl and R⁷ is H. These amine oxides are illustrated by C₁₂-₁₄ alkyldimethyl amine oxide, hexadecyl dimethylamine oxide, octadecylamine oxide.

A preferred amine oxide material is lauryl dimethylamine oxide, also known as dodecyldimethylamine oxide or DDAO.

Betaines may be alkyldimethyl betaines or alkylamido betaines, wherein the alkyl groups have C₁₂-₁₈ chains.

In a preferred embodiment of the invention, the one or more surfactants of component Z2) of the detergent compositions of the invention are selected from the group consisting of linear alkyl benzene sulfonates, alkyl ether sulfates, alkyl sulfates, soaps, nonionic surfactants, amine oxides and betaines, and preferably the one or more surfactants of component Z2) of the detergent compositions of the invention are selected from the group consisting of linear alkyl benzene sulfonates, alkyl ether sulfates, alkyl sulfates, soaps and nonionic surfactants.

### Additional Surfactants

Other surfactants than the preferred LAS, AES, AS, soaps and nonionic surfactants may be added to the mixture of detersive surfactants.

The detergent compositions of the invention comprise the one or more surfactants of component Z2) preferably in an amount of at least 3 wt.-%, more preferably in an amount from 3 to 65 wt.-%, even more preferably in an amount from 4 to 60 wt.-% and particularly preferably in an amount from 5 to 55 wt.-%, in each case based on the total weight of the detergent composition.

### Further Optional Ingredients

In addition to the one or more polyesters of component Z1) and the one or more surfactants of component Z2), the detergent compositions of the invention may comprise one or more optional ingredients, e.g. they may comprise conventional ingredients commonly used in detergent compositions, especially laundry detergent compositions. Examples of optional ingredients include, but are not limited to builders, bleaching agents, bleach active compounds, bleach activators, bleach catalysts, photobleaches, dye transfer inhibitors, colour protection agents, anti-redeposition agents, dispersing agents, fabric softening and antistatic agents, fluorescent whitening agents, enzymes, enzyme stabilizing agents, foam regulators, defoamers, malodour reducers, preservatives, disinfecting agents, hydrotropes, fibre lubricants, anti-shrinkage agents, buffers, fragrances, processing aids, colorants, dyes, pigments, anti-corrosion agents, fillers, stabilizers and other conventional ingredients for detergent compositions such as washing or laundry detergent compositions.

### Polyalkoxylated Polyethyleneimine

For detergency boosting, it is advantageous to use a second polymer alongside the one or more polyesters of component Z1) in the detergent compositions of the present invention. This second polymer is preferably a polyalkoxylated polyethyleneimine (EPEI). Polyethylene imines are materials composed of ethylene imine units —CH₂CH₂NH— and, where branched, the hydrogen on the nitrogen is replaced by another chain of ethylene imine units. These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like.

### Other Polymers

In addition to the one or more polyesters of component Z1) and the optional EPEI, the detergent compositions of the invention may comprise other polymeric materials, for example: dye transfer inhibition polymers, anti-redeposition polymers and cotton soil release polymers, especially those based on modified cellulosic materials. Especially, if EPEI is not present, the detergent compositions of the invention may further comprise a polymer of polyethylene glycol and vinyl acetate, for example the lightly grafted copolymers described in WO 2007/138054. Such amphiphilic graft polymers based on water soluble polyalkylene oxides as graft base and side chains formed by polymerisation of a vinyl ester component have the ability to enable reduction of surfactant levels whilst maintaining high levels of oily soil removal.

### Hydrotropes

In the context of this invention a hydrotrope is a solvent that is neither water nor conventional surfactant that aids the solubilisation of the surfactants and other components, especially polymer and sequestrant, in the liquid to render it isotropic. Among suitable hydrotropes there may be mentioned as preferred: monopropylene glycol (MPG), glycerol, sodium cumene sulfonate, ethanol, other glycols, e.g. dipropylene glycol, diethers and urea. MPG and glycerol are preferred hydrotropes.

### Enzymes

It is preferable that one or more enzymes selected from protease, mannanase, pectate lyase, cutinase, lipase, amylase, and cellulase may be present in the detergent compositions of the invention. Less preferred additional enzymes may be selected from esterase, peroxidase and oxidase. The enzymes are preferably present with corresponding enzyme stabilizers. The total enzyme content in the detergent compositions of the invention is preferably from 0 to 5 wt.-%, more preferably from 0.2 to 4 wt.-% and even more preferably from 0.4 to 2 wt.-%, in each case based on the total weight of the detergent composition.

### Sequestrants

Sequestrants are preferably included. Preferred sequestrants include organic phosphonates, alkanehydroxy phosphonates and carboxylates available under the DEQUEST trademark from Thermphos. The preferred sequestrant level is less than 10 wt.-% and preferably less than 5 wt.-% of the detergent composition of the invention. A particularly preferred sequestrant is HEDP (1-Hydroxyethylidene-1,1,-diphosphonic acid). Also suitable but less preferred as it gives inferior cleaning results is diethylenetriamine penta(methylene phosphonic acid) (DTPMP) or Heptasodium DTPMP.

### Buffers

In addition to agents optionally included for the generation of anionic surfactants, e.g. from LAS or fatty acids, the presence of buffer is preferred for pH control. Possible buffers are one or more ethanolamines, e.g. monoethanolamine (MEA) or triethanolamine (TEA). They are preferably used in the detergent compositions of the invention at levels of from 1 to 15 wt.-%, based on the total weight of the detergent composition. Other suitable amino alcohol buffer materials may be selected from the group consisting of compounds having a molecular weight above 61 g/mol, which includes MEA. Suitable materials also include, in addition to the already mentioned materials: monoisopropanolamine, diisopropanolamine, triisopropanolamine, monoamino hexanol, 2-[(2-methoxyethyl) methylamino]-ethanol, propanolamine, N-methylethanolamine, diethanolamine, monobutanolamine, isobutanolamine, monopentanolamine, 1-amino-3-(2-methoxyethoxy)-2-propanol, 2-methyl-4-(methylamino)-2-butanol and mixtures thereof.

Potential alternatives to amino ethanol buffers are alkali hydroxides such as sodium hydroxide or potassium hydroxide.

### Builders

Further washing and cleaning ingredients which may be present in the detergent compositions of the invention include inorganic and/or organic builders in order to reduce the degree of hardness of the water. These builders may be present in the detergent compositions of the invention in amounts of from about 5 to about 80 wt.-%, based on the total weight of the detergent compositions. Inorganic builders include, for example, alkali metal, ammonium and alkanolammonium salts of polyphosphates, silicates, carbonates, sulfates and aluminosilicates.

Suitable organic builders include polycarboxyl compounds, such as, for example, ether polycarboxylates, ether hydroxypolycarboxylates, copolymers of maleic anhydride with ethylene or vinyl methyl ether, 1,3,5-trihydroxybenzene-2,4,6-trisulfonic acid and carboxymethyloxysuccinic acid, the alkali metal, ammonium and substituted ammonium salts of polyacetic acids, such as, for example, ethylenediaminetetraacetic acid and nitrilotriacetic acid, and also polycarboxylic acids, such as mellitic acid, succinic acid, oxydisuccinic acid, polymaleic acid, benzene-1,3,5-tricarboxylic acid, carboxymethyloxysuccinic acid, and soluble salts thereof. Builders based on citrates, for example citric acid and its soluble salts, in particular the sodium salt, are preferred polycarboxylic acid builders, which can also be used in granulated compositions, in particular together with zeolites and/or sheet silicates.

It may be advantageous to include fluorescer and/or bleach catalyst in the detergent compositions of the invention as further high efficiency performance additives. Perfume and colorants will also desirably be included. The detergent compositions of the invention may additionally contain viscosity modifiers, foam boosting agents, preservatives (e.g. bactericides), pH buffering agents, polyelectrolytes, anti-shrinking agents, anti-wrinkle agents, anti-oxidants, sunscreens, anti-corrosion agents, drape imparting agents, anti-static agents and ironing aids. The detergent compositions of the invention may further comprise pearlisers and/or opacifiers or other visual cues and shading dye.

### Form, Packaging and Dosing

The detergent compositions of the invention may be in solid or in liquid form, including a gel form. The detergent compositions of the invention may be packaged as unit doses in a polymeric film soluble in the wash water. Alternatively, the detergent compositions of the invention may be supplied in multidose plastics packs with a top or bottom closure. A dosing measure may be supplied with the pack either as a part of the cap or as an integrated system.

The polyesters of the invention may be used in substance, i.e. as granules, but may also be provided as solutions or dispersions. The latter two exhibit beneficial handling properties and are more easily dosed. Preferably, the solutions or dispersions comprise the polyesters of the invention in an amount from 25 to 70 weight-% based on the total weight of the solution or dispersion. Suitable solvents for such solutions or dispersions are for example water, ethanol, propanol, butanol, ethylene glycol, 1 ,2-propylene glycol, 1,3-propylene glycol, 1 ,2-butylene glycol, 1,3-butylene glycol, 1,4-butylene glycol, butyl glycol, butyl diglycol and butyl polyglycol. These solvents are preferably used in an amount from 25 to 75 wt.-% and more preferably in an amount from 30 to 75 wt.-%, in each case based on the total weight of the solution or dispersion. Even more preferably, the inventive solutions or dispersions comprise water and a second solvent different from water and selected from the group above.

A further subject matter of the invention is solutions or dispersions comprising one or more polyesters of the invention, preferably in an amount from 25 to 70 wt.-%, based on the total weight of the solution or dispersion, and one or more solvents selected from the group consisting of water, ethanol, propanol, butanol, ethylene glycol, 1,2-propylene glycol, 1,3-propylene glycol, 1,2-butylene glycol, 1,3-butylene glycol, 1,4-butylene glycol, butyl glycol, butyl diglycol and butyl polyglycol, preferably in an amount from 25 to 75 wt.-% and more preferably in an amount from 30 to 75 wt.-%, in each case based on the total weight of the solution or dispersion. Even more preferably, the inventive solutions or dispersions comprise water and a second solvent different from water and selected from the group above.

These inventive solutions or dispersions are liquid and comprise the one or more polyesters of the invention in a high concentration. They may e.g. represent high concentrated liquid handling forms of the inventive polyesters and may be used for the preparation of inventive detergent compositions to be used by end-consumers. These inventive solutions or dispersions comprising the one or more polyesters of the invention in a high concentration nevertheless possess an advantageous low viscosity in the sense that this viscosity causes, for example, no issues on pumpability or dosage consistency during the preparation of the inventive detergent compositions to be used by end-consumers.

The groups (C₂H₄) in the terminal groups of the formula (III-a) or in the structural units of the formula (IV-a) preferably are of the formula —CH₂—CH₂—.

The groups (C₃H₆) in the terminal groups of the formula (III-a) or in the structural units of the formula (IV-a) preferably are of the formula —CH(CH₃)—CH₂— or —CH₂—CH(CH₃)—, i.e. of the formula:

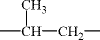

or

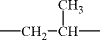

The groups (C₄H₈) in the terminal groups of the formula (III-a) or in the structural units of the formula (IV-a) preferably are of the formula —CH(CH₃)—CH(CH₃)—, i.e. of the formula:

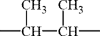

In the polyesters of the invention, the terminal groups or structural units of the formulae (II), (III-a) or (IV-a) may be linked directly to structural units of the formula (I) resulting in ester groups.

It is to be understood that the polyesters of the invention are typically prepared by polycondensation processes. This leads to statistically determined mixtures of polyesters in which a mixture of molecular species with a distribution around a molar average is obtained.

The following paragraphs will show illustrative, but by no means limiting, structural entities that can be found in the polyesters of the invention.

The structural units of the formula (I) and optional additional di- or polycarboxylic acid-derived structural units are linked indirectly, preferably via the structural units of the formula (II), which - in the case of structural units of the formulae (I) and (II) results in the following structural entity:

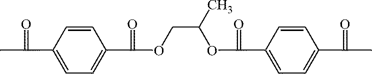

Preferably, the terminal group of the formula (III-a) is linked to an acyl group derived from a dicarboxylic acid, preferably to the structural unit of the formula (I), which - in the case of structural unit of the formula (I) and terminal group of the formula (III-a) - results in the following structural entity:

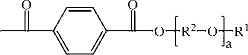

Further preferred embodiments of the invention may arise from the combination of above described preferred embodiments.

### EXAMPLES

The examples below are intended to illustrate the invention in detail without, however, limiting it thereto. Unless explicitly stated otherwise, all percentages given are percentages by weight (% by wt. or wt.-%).

Key to reactants used in the examples:

| | |
|---|---|
| DMT | dimethyl terephthalate |

| | |
|---|---|
| EO | ethylene oxide |
| PG | 1,2-propylene glycol |
| IPT | tetraisopropyl orthotitanate |
| NaOAc | sodium acetate |
| Tallow-25EO | Tallow alcohol (C16/18, C18 rich, saturated (hydrogenated)) ethoxylate with 25 EO (Genapol® T 250, Clariant) |
| Tallow-50EO | Tallow alcohol (C16/18, C18 rich, saturated (hydrogenated)) ethoxylate with 50 EO (Genapol® T 500, Clariant) |
| Tallow-80EO | Tallow alcohol (C16/18, C18 rich, saturated (hydrogenated)) ethoxylate with 80 EO (Genapol® T 800, Clariant) |
| Tallow-120EO | Tallow alcohol (C16/18, C18 rich, saturated (hydrogenated)) ethoxylate with 120 EO |
| Lauryl-80EO | Lauryl alcohol (C12/14, C12 rich) ethoxylate with 80 EO |
| Isotridecyl-100EO | Isotridecyl alcohol (C11-C14 iso alcohol, C13 rich) ethoxylate with 100 EO |

### Example 1: Polyester Preparation

General procedure for the preparation of the polyesters of the examples. The polyester synthesis is carried out by the reaction of dimethyl terephthalate (DMT), 1,2-propylene glycol (PG) and one or more poly(alkyleneglycol)monoalkylethers or one or more poly(alkyleneglycol)monoalkenylethers or mixtures thereof (collectively “Cap”), using sodium acetate (NaOAc) and tetraisopropyl orthotitanate (IPT) as the catalyst system. The synthesis is a two-step procedure. The first step is a transesterification and the second step is a polycondensation.

### Inventive Polyester Example 1

38.8 g (0.2 mol) of dimethyl terephthalate (DMT), 30.4 g (0.4 mol) of 1,2-propylene glycol (PG), 271.6 g (0.2 mol) of Tallow-25EO and 0.5 g of sodium acetate (anhydrous) (NaOAc) are weighed into a reaction vessel at room temperature. For the melting process and homogenization, the mixture is heated up to 70° C. 200 µL (0.7 mmol) of tetraisopropyl orthotitanate (IPT) is added and the mixture is further heated up to 170° C. for 1 hour and then up to 210° C. for a further 1 hour sparged by a nitrogen stream. During the transesterification methanol is released from the reaction and is distilled out of the system (distillation temperature < 55° C.). After 2 hours at 210° C. nitrogen is switched off and the pressure is reduced to 400 mbar over 3 hours. Subsequently, the mixture is heated up to 230° C. At 230° C., the pressure is reduced to 1 mbar over 160 minutes. Once the polycondensation reaction has started, 1 ,2-propylene glycol is distilled out of the system. The mixture is stirred for 4 hours at 230° C. and a pressure of 1 mbar. The reaction mixture is cooled down to 140 - 150° C. Vacuum is released with nitrogen and the molten polymer is transferred out of the reactor.

Inventive polyester examples 2 to 14 are synthesized according to the general procedure as described above for inventive polyester example 1 with monomer type and dosage described below (see Table 1).

TABLE 1

Inventive polyester examples 1 to 14

| Inventive polyester example | DMT [g] | PG [g] | Cap [type] | Cap [g] | Yield [g] | MW [g/mol] |
|---|---|---|---|---|---|---|
| 1 | 38.8 | 30.4 | Tallow-25EO | 271.6 | 308.2 | 6372 |
| 2 | 97.1 | 76.1 | Tallow-25EO | 271.6 | 371.8 | 5628 |
| 3 | 58.3 | 45.7 | Tallow-25EO | 271.5 | 328 | 6572 |
| 4 | 48.6 | 38.1 | Tallow-50EO | 351.3 | 398.5 | 8264 |
| 5 | 77.7 | 60.9 | Tallow-50EO | 245.6 | 354 | 6676 |
| 6 | 58.3 | 45.7 | Tallow-50EO | 245.6 | 304.7 | 8663 |
| 7 | 48.6 | 38.1 | Tallow-80EO | 378.1 | 428.2 | 10849 |
| 8 | 116.5 | 91.3 | Tallow-80EO | 378.1 | 502.9 | 9781 |
| 9 | 97.1 | 76.1 | Tallow-80EO | 378.1 | 478.1 | 10096 |
| 10 | 58.3 | 45.7 | Tallow-120EO | 275 | 336.1 | 10068 |
| 11 | 29.1 | 22.8 | Lauryl-80EO | 155.9 | 186.6 | 14284 |
| 12 | 77.7 | 60.1 | Lauryl-80EO | 155.9 | 235.2 | 10331 |
| 13^{a} | 93.2 | 73.1 | Lauryl-80EO | 498.8 | 594.8 | 12370 |
| 14 | 77.7 | 60.9 | Isotridecyl-100EO | 401.2 | 482.3 | 10631 |

^{a} 400 µL IPT and 1.0 g NaOAc were used

### Example 2: Compositions Containing Polyesters and Their Viscosity

A series of exemplary liquid laundry detergent compositions containing no polyester (reference composition A), containing a comparative polyester (comparative composition B) or containing inventive polyester (inventive compositions C-M) were prepared according to Table 2.

Key to ingredients used in the compositions of Table 2

| | |
|---|---|
| LAS | is C₁₂₋₁₄ linear alkylbenzene sulfonate, sodium salt |
| SLES 2EO | is sodium lauryl ether sulfate with 2 moles EO (Genapol® LRO, Clariant). |
| Nl 7EO | is C₁₂₋₁₅ alcohol ethoxylate 7EO nonionic (Genapol® LA070, Clariant) |

| | |
|---|---|
| Fatty Acid | is a C₁₂₋₁₈ stripped palm kernel fatty acid |
| SRP | is a polyester prepared according to examples from Table 1 |
| Texcare® SRN 260 | is a nonionic soil release polymer (Clariant) |

TABLE 2

Liquid laundry detergent compositions for performance testing

| Ingredient | Composition A (reference) | Composition B (comparative) | Compositions C-M (inventive) |
|---|---|---|---|
| | wt.-% a.m. | wt.-% a.m. | wt.-% a.m. |
| LAS | 5.2 | 5.2 | 5.2 |
| SLES 2EO | 6.5 | 6.5 | 6.5 |
| Nl 7EO | 5.2 | 5.2 | 5.2 |
| Fatty Acid | 2.8 | 2.8 | 2.8 |
| Glycerol | 2.4 | 2.4 | 2.4 |
| Ethanol | 1.2 | 1.2 | 1.2 |
| Sodium citrate | 1.7 | 1.7 | 1.7 |
| Sodium tetraborate decahydrate | 2.0 | 2.0 | 2.0 |
| Sodium chloride | 1.0 | 1.0 | 1.0 |
| Texcare® SRN 260 | 0 | 1.0 | 0 |
| SRP | 0 | 0 | 1.0 |
| Demineralized water and NaOH to adjust pH | ad 100 | ad 100 | ad 100 |
| pH Value | 8.4 | 8.4 | 8.4 |

a.m. active matter

The viscosities of the compositions of Table 2 were determined using a Malvern Kinexus equipped with a CP 4°/40 mm, at a temperature of 25° C. and at a shear rate of 200 s⁻¹ and rounded to the nearest 5 mPas. The appearance of the compositions was determined visually. The results are summarized in Table 3.

TABLE 3

Viscosity and appearance of liquid detergent compositions

| Composition | Inventive polyester example | Viscosity [mPas] | Appearance at room temperature |
|---|---|---|---|
| A (reference) | - | 580 | Clear |
| B (comparative) | - | 285 | Clear |
| C (inventive) | 1 | 700 | Clear |
| D (inventive) | 3 | 865 | Clear |
| E (inventive) | 4 | 1075 | Clear |
| F (inventive) | 6 | 1235 | Clear |
| G (inventive) | 7 | 920 | Clear |
| H (inventive) | 9 | 1215 | Clear |
| I (inventive) | 10 | 1305 | Clear |
| J (inventive) | 11 | 815 | Clear |
| K (inventive) | 12 | 1020 | Clear |
| L (inventive) | 13 | 1580 | Clear |
| M (inventive) | 14 | 1340 | Clear |

### Example 3: Soil Release Performance of Inventive Polyesters

Detergent compositions of Example 2 were tested for their soil release performance according to the “Dirty-Motor Oil” Test (DMO-Test) using a Lini Apparatus under the following conditions (see Table 4).

TABLE 4

Conditions for testing of soil release performance

| Equipment | Linitest Plus (SDL Atlas) |
|---|---|
| Water hardness | 14°dH |
| Washing temperature | 40° C. |
| Washing time | 30 minutes |
| Detergent concentration | 4.3 g/l liquid detergent |
| Soiled Fabric : Liquor Ratio | 1 : 40 |

As test fabric, white polyester standard swatches (WFK 30A from WFK Testgewebe GmbH) were used. The fabrics were prewashed three times with the liquid detergent compositions. The swatches were then rinsed, dried and soiled with 25 µl of dirty motor oil. After 1 hour the soiled fabrics were washed again with the same stored laundry detergent compositions used in the pre-washing step. After rinsing and drying the washed swatches, a measurement of the remission of the stained fabric at 457 nm was made using a spectrophotometer (Datacolor 650).

The soil release performance is shown as an improvement in soil removal of the swatches washed with a composition containing an inventive polyester as additive compared with the same composition containing no additive (Composition A)

$$Δ R = {R}_{w i t h a d d i c t i v e} - {R}_{w i t h o u t a d d i t i v e}$$

The washing results obtained for the inventive laundry detergent compositions comprising the polyesters of the invention are expressed as ΔR along with the standard deviations (SD) (see Table 5).

TABLE 5

Soil release test results

| Detergent composition | Soil release test result | |
|---|---|---|
| | ΔR | SD |
| I (inventive) | 13.0 | 2.1 |
| J (inventive) | 15.4 | 2.1 |
| K (inventive) | 16.2 | 1.4 |
| L (inventive) | 17.6 | 1.0 |
| M (inventive) | 16.9 | 0.9 |

The results in Table 5 suggest that the inventive polyesters show a significant soil release effect.

Similar tests with Compositions C to H suggest that the polyesters provide a significant soil release effect.

1. A polyester comprising one or more structural units of the formula (I) 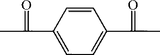
and one or more structural units of the formula (II) 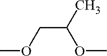
and one or more terminal groups of the formula (III-a) or mixtures thereof 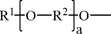
wherein
R¹ is a linear or branched, alkyl group comprising from 7 to 30 carbon atoms or a linear or branched, alkenyl group comprising one or more double bonds and from 7 to 30 carbon atoms or mixtures thereof,
a is, based on a molar average, a number from 1 to 200, and
R² is a linear or branched alkylene group (CₘH₂ₘ) with m being a number from 2 to 10 or mixtures thereof, .

2. The polyester according to claim 1, characterized in that R¹ is selected from the group consisting of linear or branched C₁₀-C₁₅ alkyl, cocoyl, partially or totally hydrogenated variants of cocoyl, talloyl, partially or totally hydrogenated variants of talloyl and mixtures thereof.

3. The polyester according to claim 1, characterized in that R¹ is a linear or branched, alkyl group comprising from 10 to 15 carbon atoms or mixtures thereof.

4. The polyester according to claim 1, characterized in that it further comprises one or more polyalkyleneglycol-derived structural units of the formula (IV-a) 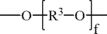
or mixtures thereof, wherein
f is, based on a molar average, a number from 2 to 200, and
R³ is a linear or branched alkylene group (CₙH₂ₙ), with n being a number from 2 to 10 or mixtures thereof, .

5. The polyester according to claim 1, characterized in that the amount of the one or more terminal groups of the formula (III-a) or mixtures thereof is at least 40 wt.-%, based on the total weight of the polyester.

6. The polyester according to claim 1, characterized in that the combined amount of the one or more structural units of the formula (I), and the one or more structural units of the formula (II), and the one or more terminal groups of the formula (III-a) or mixtures thereof, and, if present, the one or more polyalkyleneglycol-derived structural units of the formula (IV-a) or mixtures thereof, is at least 50 wt.-%, based on the total weight of the polyester.

7. The polyester according to claim 1, characterized in that its weight average molecular weight (M_{w}) is from 5000 to 20000 g/mol.

8. The polyester according to claim 1, characterized in that the number of structural units of the formula (I) is, based on a molar average, from 2 to 60, .

9. The polyester according to claim 1, characterized in that it
consists of
a1) one or more structural units of the formula (I) and
a2) one or more structural units of the formula (II) and
a3) one or more terminal groups of the formula (III-a) or mixtures thereof.

10. A process for the preparation of a polyester comprising one or more structural units of the formula (I) 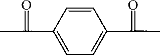
and one or more structural units of the formula (II) 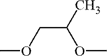
and one or more terminal groups of the formula (III-a) or mixtures thereof 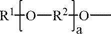
wherein
R¹ is a linear or branched, alkyl group comprising from 7 to 30 carbon atoms or a linear or branched, alkenyl group comprising one or more double bonds and from 7 to 30 carbon atoms or mixtures thereof,
a is, based on a molar average, a number from 1 to 200, and
R² is a linear or branched alkylene group (CₘH₂ₘ) with m being a number from 2 to 10 or mixtures thereof,
comprising the steps of: heating one or more substances of the formula Q1—OOC—C₆H₄—COO—Q2, wherein Q1 and Q2, independently of one another, are selected from the group consisting of H and (C₁-C₄)-alkyl , and 1,2-propyleneglycol, and one or more substances of the formula R′—[O—R²]ₐ—OH or mixtures thereof, with the addition of a catalyst, to temperatures of from 160 to 220° C., and then continuing the reaction under reduced pressure at temperatures of from 160 to 240° C.

11. A soil release agent comprising one or more structural units of the formula (I) 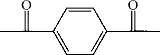
and one or more structural units of the formula (II) 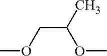
and one or more terminal groups of the formula (III-a) or mixtures thereof 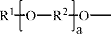
wherein
R¹ is a linear or branched, alkyl group comprising from 7 to 30 carbon atoms or a linear or branched, alkenyl group comprising one or more double bonds and from 7 to 30 carbon atoms or mixtures thereof,
a is, based on a molar average, a number from 1 to 200, and
R² is a linear or branched alkylene group (CₘH₂ₘ) with m being a number from 2 to 10 or mixtures thereof.

12. A detergent composition, comprising
Z1) one or more polyesters comprising one or more structural units of the formula (I) 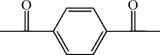
and one or more structural units of the formula (II) 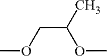
and one or more terminal groups of the formula (III-a) or mixtures thereof 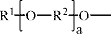
wherein
R¹ is a linear or branched, alkyl group comprising from 7 to 30 carbon atoms or a linear or branched, alkenyl group comprising one or more double bonds and from 7 to 30 carbon atoms or mixtures thereof,
a is, based on a molar average, a number from 1 to 200, and
R² is a linear or branched alkylene group (CₘH₂ₘ) with m being a number from 2 to 10 or mixtures thereof and
Z2) one or more surfactants.

13. The detergent composition according to claim 12, characterized in that it comprises the one or more polyesters of component Z1) in an amount of at least 0.1 wt.-%, based on the total weight of the detergent composition.

14. The detergent composition according to claim 12, characterized in that it comprises the one or more surfactants of component Z2) in an amount of at least 3 wt.-%, based on the total weight of the detergent composition.

15. A solution or dispersion comprising one or more polyesters comprising one or more structural units of the formula (I) 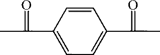
and one or more structural units of the formula (II) 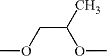
and one or more terminal groups of the formula (III-a) or mixtures thereof 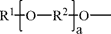
wherein
R¹ is a linear or branched, alkyl group comprising from 7 to 30 carbon atoms or a linear or branched, alkenyl group comprising one or more double bonds and from 7 to 30 carbon atoms or mixtures thereof,
a is, based on a molar average, a number from 1 to 200, and
R² is a linear or branched alkylene group (CₘH₂ₘ) with m being a number from 2 to 10 or mixtures thereof and one or more solvents selected from the group consisting of water, ethanol, propanol, butanol, ethylene glycol, 1,2-propylene glycol, 1,3-propylene glycol, 1,2-butylene glycol, 1 ,3-butylene glycol, 1,4-butylene glycol, butyl glycol, butyl diglycol, butyl polyglycol, and mixtures thereof, .

16. The polyester according to claim 1, characterized in that it consists of
b1) one or more structural units of the formula (I) and
b2) one or more structural units of the formula (II) and
b3) one or more terminal groups of the formula (III-a) or mixtures thereof, and
b4) one or more polyalkyleneglycol-derived structural units of the formula (IV-a) or mixtures thereof.
